(19) United States
(12) Patent Application Publication
(10) Pub. No.: US 2025/0026375 A1
(43) Pub. Date: Jan. 23, 2025

(54) ACCURATE BOX LOCALIZATION FOR AUTOMATIC TAGGING SYSTEM USING PHYSICAL GROUND TRUTH

(71) Applicant: AUTOBRAINS TECHNOLOGIES LTD, Tel Aviv-Yafo (IL)

(72) Inventor: Igal Raichelgauz, Tel Aviv (IL)

(73) Assignee: AUTOBRAINS TECHNOLOGIES LTD, Tel Aviv-Yafo (IL)

(21) Appl. No.: 18/355,370

(22) Filed: Jul. 19, 2023

(51) Int. Cl. B60W 60/00

(52) U.S. Cl. CPC B60W 60/0016; B60W 2420/408; B60W 2554/4026; B60W 2554/4029; B60W 2556/50

(57) ABSTRACT

A method for segmentation-based generation of bounding shapes, the method may include obtaining bounding shapes that are indicative of objects, the objects were captured in a sensed information unit; generating a cropped image for each bounding shape; segmenting each cropped image to a cropped image background and a cropped image foreground; and generating, for each cropped image, an updated bounding shape that are indicative of dimensions of the cropped image foreground of the cropped image, to provide updated bounding shapes.

### BACKGROUND

Neural networks, also known as artificial neural networks or deep learning models, are a type of machine learning algorithm that can be used to learn patterns in data and make predictions or classifications based on those patterns. In order to train a neural network, the data used to train the model must be labeled or tagged with the correct output or classification. This is because the neural network uses this labeled data to learn the patterns in the data and make predictions or classifications based on those patterns.

Overall, labeled data is an essential part of training and evaluating neural networks, and it is necessary in order for the neural network to be able to learn patterns in the data and make accurate predictions or classifications

Object detection is a task in which a machine learning model is trained to identify and locate objects of interest in images or video. In order to train a neural network for object detection, the data used to train the model must be labeled with the location and type of each object of interest in the image. This is because the neural network needs to be provided with this information in order to learn to identify and locate the objects of interest in the image.

Labeling data for object detection in a neural network typically involves annotating the images or video with bounding boxes around the objects of interest, and assigning a label or class to each bounding box. This can be done manually by a human annotator, or it can be done automatically using machine learning or computer vision techniques.

There is a growing need to guarantee that bounding shapes are accurately placed on boundaries of the object. This is due to the fact that the bounding shape itself will determine object image domain dimensions for the task of real world distance estimation.

### SUMMARY

There may be provided a method, a system and a non-transitory computer readable medium for accurate box localization for automatic tagging system using physical ground truth.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a vehicle, a camera and an image that includes a bounding shape;

FIG. 3 illustrates an example of a method;

FIG. 4 illustrates an example of a vehicle; and

FIG. 5 illustrates an example of a method.

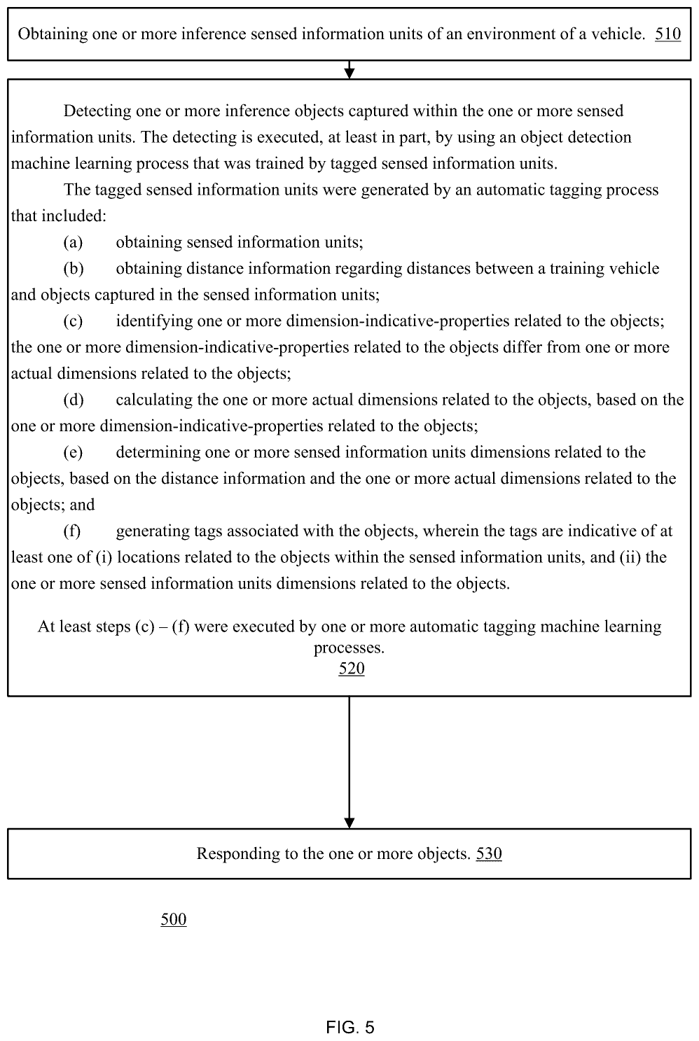

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

The specification and/or drawings may refer to a processor. The processor may be a processing circuit. The processing circuit may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

The specification and/or drawings may refer to a sensed information unit. In the content of driving—the sensed information unit may capture or may be indicative of a natural signal such as but not limited to signal generated by nature, signal representing humans and/or human behaviors, signals indicative of an environment of a vehicle, and the like. Examples of such sensed information units may include a radiation generated image such as a radar image, a sonar image, a visible light image, an infrared image, a thermal image, an ultraviolet image, a virtual reality augmented image, and the like. A non-image sensed information unit may be captured. Examples of sensors include radiation sensors such as radar, sonar, visual light camera, infrared sensor, ultrasound sensor, electro-optics sensor, LIDAR (light detection and ranging), etc.

There may be provided a system, a method, and a non-transitory computer readable medium for automatic tagging.

A bounding shape may be a bounding box or a bounding polygon that is not a box or have any shape other than a box-including a curved shapes, a partially curves shape, and the like.

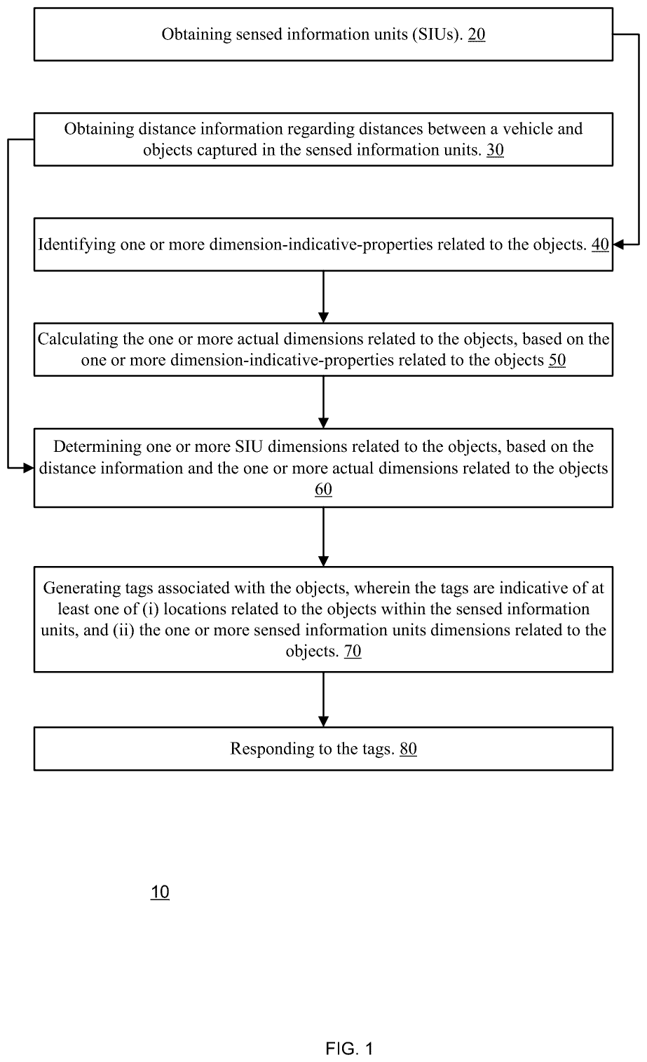

FIG. 1 illustrates an example of method 10 for automatic tagging.

Method 10 may include steps 20, 30, 40, 50, 60, 70.

Step 20 may include obtaining sensed information units (SIUs).

Step 20 may include capturing the SIUs or receiving the SIUs. One or more SIU can be received and one or more other SIU may be captured.

Step 30 may include obtaining distance information regarding distances between a vehicle and objects captured in the sensed information units.

Step 30 may include receiving the distance information. Step 30 may include generating the distance information. Distance information regarding one or more objects may be generated and distance information regarding one or more other objects may be received.

Step 30 may include using one or more depth sensors. Examples of depth sensors include a LIDER, a global positioning system (GPS) unit, a radar and a sonar.

Step 20 may be followed by step 40 of identifying one or more dimension-indicative-properties related to the objects.

A dimension-indicative-property related to an object is indicative of an actual dimension of an object—while being different from the actual dimension itself.

An object may be a vehicle. A dimension-indicative-property of the vehicle may be at least one out of a manufacturer of the vehicle, a model of the vehicle, a combination of a model and a year of manufacturing, or a type of a vehicle, a number of wheels of the vehicles. Any of these dimension-indicative-properties may be indicative of an exact actual dimension or at least of a range of actual dimensions. For example, a combination of a model of a vehicle and a year of the vehicle provides exact dimensions of the vehicle-such as exact width, height and length. If dimensions of a certain model of a vehicle changed over the years—than the model of the vehicle provides an indication of dimensions ranges that cover the dimensions of the model over the years.

A type of a vehicle may be, for example a truck, a van, a car, and a bus.

The vehicle may be a two-wheeled vehicle and the type of the vehicle may be a bicycle, a motorcycle and a scooter.

The type of a vehicle may provide a coarser range of dimensions—for example a truck exhibits certain dimensions ranges that may exceed the dimensions ranges of a private car.

An object may be a pedestrian. A dimension-indicative-property of the vehicle may be an age range of the pedestrian. The age range may be selected out of a child, an infant and an adult. The age range may be associated with a typical height range or other dimension value range. An infant is usually smaller than a child that is usually smaller than an adult.

Step 40 may be followed by step 50 of calculating the one or more actual dimensions related to the objects, based on the one or more dimension-indicative-properties related to the objects. The calculating may be based on a dimension-indicative-properties to dimension mapping that maps dimension-indicative-properties to dimensions.

An actual dimension related to an object may be a dimension of an object, a dimension of a bounding shape that are indicative of dimensions of an object, and the like. A bounding shape may or may not surround the object.

Steps 30 and 50 may be followed by step 60 of determining one or more SIU dimensions related to the objects, based on the distance information and the one or more actual dimensions related to the objects. Step 60 may include setting a bounding shape to fit the SIU dimensions of the objects.

A SIU dimension of an object may represent the size of the object within the SIU—for example the number of SIU elements (for example-pixels) associated with the object.

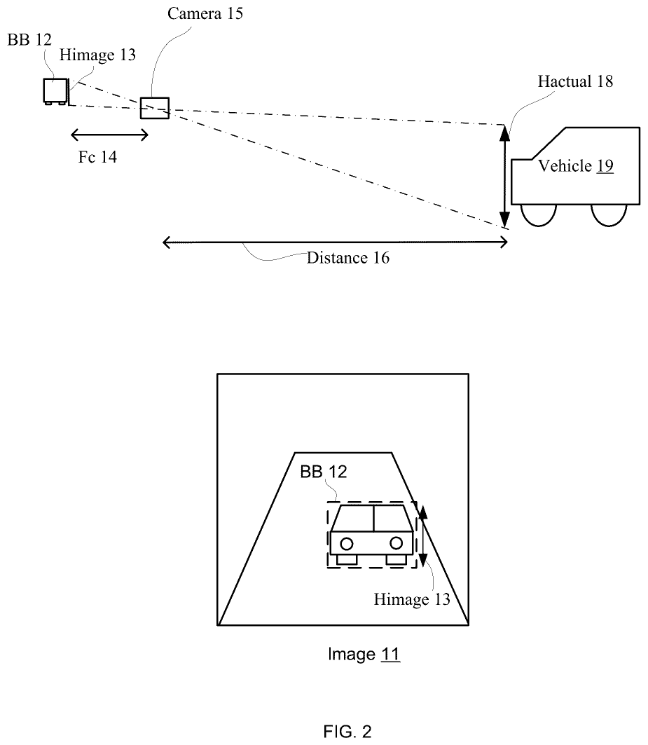

There is a known relationship between a dimension associated with the object, the distance to the object and the SIU dimension related to the object. See, for example FIG. 2. For example-referring to an actual height of the object and the SIU height of the object (height of the object within the SIU)—the SIU height of the object may be accurately determined based on the actual height of the object, the distance between the camera and the object and the focal length of the camera. Because the distance, the actual height of the object and the focal length of the camera are accurately known—the accurate SIU height of the object is known—and the bounding shape of the object may be set to have a height that equals the SIU height of the object. The same is applicable to the width of the object-which allows to set the width of the bounding shape to the actual width of the object. Step 60 provides highly accurate bounding shapes-which improves the accuracy of training.

Step 70 may include generating tags associated with the objects, wherein the tags are indicative of at least one of (i) locations related to the objects within the sensed information units, and (ii) the one or more sensed information units dimensions related to the objects.

At least some steps of method 10 are executed by one or more machine learning processes. For example—at least steps 40, 50, 60 and 70 are executed by the one or more (for example one) machine learning processes.

Step 70 may be followed by step 80 of responding to the tags.

Step 80 may include at least one out of:
Generating tagged sensed information units that comprise the sensed information units and the tags.
Training one or more other machine learning processes with at least a first part of the tagged sensed information units.
Testing one or more other machine learning processes with at least a second part of the tagged sensed information units.
Exporting the one or more other machine learning processes to a vehicle.
Exporting parameters of the one or more other machine learning processes to a vehicle.
Utilizing, by the vehicle, the one or more other machine learning processes during driving of the vehicle.
Performing SIUs processing by a vehicle during a driving session of the vehicle. The processing may include object detection, generating of bounding shapes, and the like.
Performing an autonomous driving related operation by the one or more other machine learning processes. The one or more other machine learning processes were trained using at least some of the tagged sensed information units.

The tagged sensed information units include accurate bounding shapes—and the training induces the one or more other machine learning processes to generate accurate bounding shapes.

FIG. 2 illustrates an example of an image 11, a bounding shape (BB) 12 of a vehicle within the image, and various other elements. FIG. 2 illustrates a relationship between a height (within an image) of a BB that sounds vehicle. The BB 12 has a height denoted Himage 13. The image 11 is acquired by camera 15 that has a focal length Fc 14. There is a distance (d) 16 between the camera 15 and the actual vehicle 19. The actual vehicle 19 has an actual height Hactual 18.

The relationship is: Himage=Fc*Hactual/d.

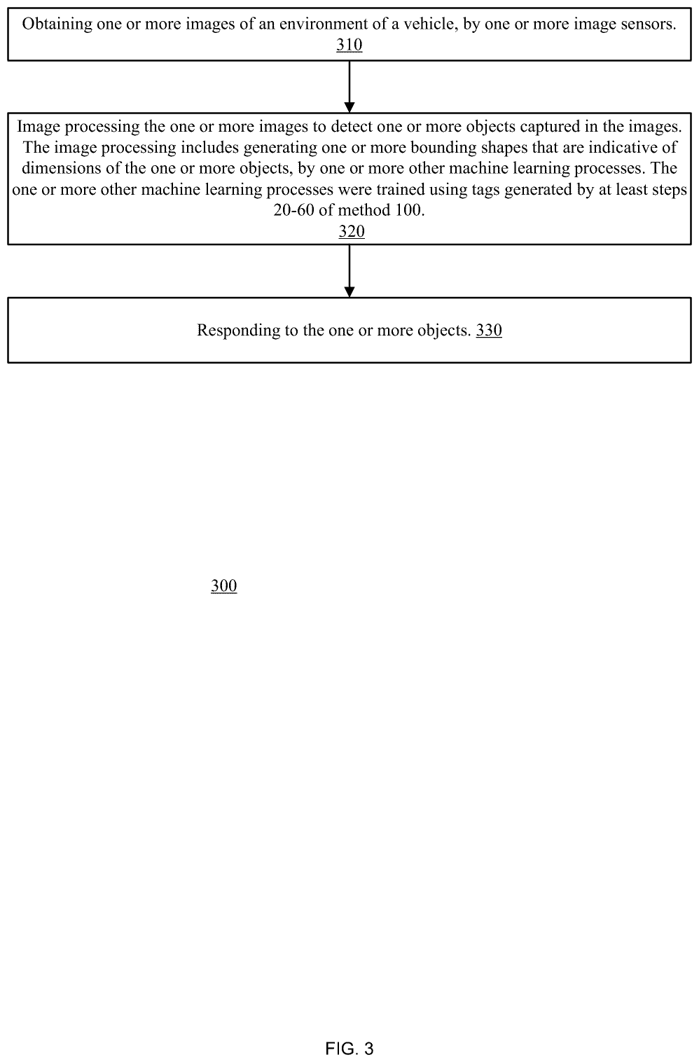

FIG. 3 illustrates an example of method 300.

Method 300 may start by step 310 of obtaining one or more images of an environment of a vehicle, by one or more image sensors. The one or more images are obtained during a driving session of a vehicle.

Step 310 may be followed by step 320 of image processing the one or more images to detect one or more objects captured in the images. The image processing includes generating one or more bounding shapes that are indicative of dimensions of the one or more objects, by one or more other machine learning processes. The one or more other machine learning processes were trained using tags generated by at least steps 20-60 of method 100.

Step 320 may be followed by step 330 of responding to the one or more objects. Step 330 may include at least one of:
Performing one or more autonomous driving related operations—for example autonomously driving an autonomous vehicle or performing an autonomous advance driver assistance system (ADAS) operation—for example changing lane or braking without human driver intervention.
Performing one or more ADAS operation which requires a human driver operation.

Method 300 may be executed in real time—which is mandatory as various autonomous driving operations and/or driving assistance operations must be executed in real time—and processing images that may include even millions of pixels is a highly complex task that requires non-transitory processors and/or processing circuits.

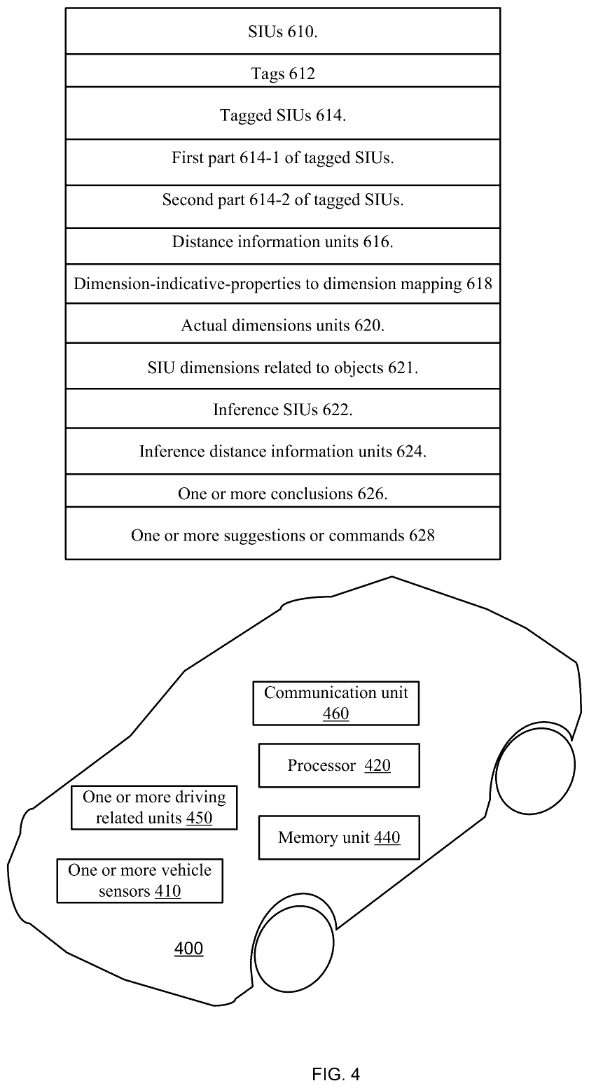

FIG. 4 is an example of a vehicle 400, SIUs, tags and other data elements.

FIG. 4 also illustrates SIUs 610, tags 612, tagged SIUs 614 that have a first part 614-1 and a second part 614-2, distance information units 616, dimension-indicative-properties to dimension mapping 618, actual dimensions units 620, SIU dimensions related to objects 621, inference SIUs 622, inference distance information units 624, one or more conclusions 626, and one or more suggestions or commands 628.

The generation of the tags 612 may include obtaining the SIUs 610 (see, for example step 20 of method 10), obtaining the distance information units 616 (see, for example, step 30 of method 10), using the dimension-indicative-properties to dimension mapping 618 to determine the actual dimensions units 620 (see, for example, step 50 of method 10), and determining the SIU dimensions related to objects 621 (see, for example, step 60 of method 10).

The first part 614-1 may be used to train one or more other machine learning processes (see, for example, step 80 of method 10). The second part 614-1 may be used to test one or more other machine learning processes (see, for example, step 80 of method 10).

An inference process may include using the one or more other machine learning processes during image processing of the inference SIUs (see, for example steps 310 and 320 of method 300). The inference process may include obtaining the inference distance information units 624 and generating (i) one or more conclusions 626 regarding the objects and/or regarding a driving of the vehicle, and/or (ii) one or more suggestions or commands 628 regarding the driving of the vehicle. For example-commands for executing an autonomous step related to the driving of a vehicle, or a suggestion to perform a step by a human driver.

Vehicle 400 may include:
One or more vehicle sensors 410 configured to generate one or more second SIUs. The vehicle may include one or more distance sensors for providing second distance information units 624. The one or more vehicle sensors 410 may or may not include the one or more distance sensors.
Processor 420 that is configured to process the one or more second SIUs to detect one or more objects. The processing includes generating one or more bounding shapes that are indicative of dimensions of one or more objects within the one or more images, by one or more other machine learning processes 422. The processing may include processing one or more second distance information units.
Response unit 430 that is configured to respond to the outcome of the processing of the SIU processor.
Memory unit 440 for storing SIUs and/or instructions and/or any information.
One or more driving related units 450 such as an autonomous driving unit, an ADAS unit, a vehicle unit controlled by the autonomous driving unit, a vehicle unit controlled by the ADAS unit, an engine, a gear, a break, a battery, and the like.
Communication unit 460.

The response unit 430 may be a processor and/or a memory unit and/or communication unit and/or an autonomous driving unit and/or an ADAS unit.

The response unit 430 may be in communication with processor 420 and/or may be in communication with memory unit 440 and/or may be in communication with another communication unit and/or may be in communication with the autonomous driving unit and/or may be in communication with the ADAS unit.

The response unit may execute at least one of the following and/or may trigger at least one of the following and/or may execute at least a part of one of the following:
Performing one or more autonomous driving related operations—for example autonomously driving an autonomous vehicle or performing an autonomous advance driver assistance system (ADAS) operation—for example changing lane or braking without human driver intervention.
Performing one or more ADAS operation which requires a human driver operation.
Performing one or more autonomous driving related operations—for example autonomously driving an autonomous vehicle or performing an autonomous advance driver assistance system (ADAS) operation—for example changing lane or braking without human driver intervention.
Performing one or more ADAS operation which requires a human driver operation.

FIG. 500 illustrates an example of method 500 for object detection.

Method 500 may start by step 510 of obtaining one or more inference sensed information units of an environment of a vehicle.

Step 510 may be followed by step 520 of detecting one or more inference objects captured within the one or more sensed information units; wherein the detecting is executed, at least in part, by one or more object detection machine learning processes that were trained by tagged sensed information units.

The tagged sensed information units were generated by an automatic tagging process that included:
(a) obtaining sensed information units;
(b) obtaining distance information regarding distances between a training vehicle and objects captured in the sensed information units;
(c) identifying one or more dimension-indicative-properties related to the objects; the one or more dimension-indicative-properties related to the objects differ from one or more actual dimensions related to the objects;
(d) calculating the one or more actual dimensions related to the objects, based on the one or more dimension-indicative-properties related to the objects;
(e) determining one or more sensed information units dimensions related to the objects, based on the distance information and the one or more actual dimensions related to the objects; and
(f) generating tags associated with the objects, wherein the tags are indicative of at least one of (i) locations related to the objects within the sensed information units, and (ii) the one or more sensed information units dimensions related to the objects; and
At least steps (c)-(f) are executed by one or more automatic tagging machine learning processes

Step 520 may be followed by step 530 of responding to the objects.

Step 530 may include executing at least one of the following and/or triggering at least one of the following, and/or executing a part of one of the following:
Performing one or more autonomous driving related operations—for example autonomously driving an autonomous vehicle or performing an autonomous advance driver assistance system (ADAS) operation—for example changing lane or braking without human driver intervention.
Performing one or more ADAS operation which requires a human driver operation.
Performing one or more autonomous driving related operations—for example autonomously driving an autonomous vehicle or performing an autonomous advance driver assistance system (ADAS) operation—for example changing lane or braking without human driver intervention.
Performing one or more ADAS operation which requires a human driver operation.

Any combination of any module or unit listed in any of the figures, any part of the specification and/or any claims may be provided. Especially any combination of any claimed feature may be provided.

Any reference to the term “comprising” or “having” should be applied, mutatis mutandis, to “consisting” or to “essentially consisting of”.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on non-transitory computer readable media permanently, removably or remotely coupled to an information processing system. The non-transitory computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. Also for example, in one embodiment, the illustrated examples may be implemented as circuit located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuit or of logical representations convertible into physical circuit, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for automatic tagging, the method comprises:
(a) obtaining sensed information units;
(b) obtaining distance information regarding distances between a vehicle and objects captured in the sensed information units;
(c) identifying one or more dimension-indicative-properties related to the objects; the one or more dimension-indicative-properties related to the objects differ from one or more actual dimensions related to the objects;
(d) calculating the one or more actual dimensions related to the objects, based on the one or more dimension-indicative-properties related to the objects;
(e) determining one or more sensed information units dimensions related to the objects, based on the distance information and the one or more actual dimensions related to the objects; and
(f) generating tags associated with the objects, wherein the tags are indicative of at least one of (i) locations related to the objects within the sensed information units, and (ii) the one or more sensed information units dimensions related to the objects; and
wherein at least steps (c)-(f) are executed by using a machine learning process.

2. The method according to claim 1, wherein one or more sensed information units dimensions related to the objects are indicative of one or more dimensions of bounding shapes that are indicative of dimensions of the objects.

3. The method according to claim 1, wherein one or more sensed information units dimensions related to the objects are indicative of one or more dimensions of objects within the one or more sensed information units.

4. The method according to claim 1, wherein one of the objects is a vehicle; wherein dimension-indicative-properties of the vehicle comprises a manufacturer of the vehicle and a model of the vehicle.

5. The method according to claim 1, wherein one of the objects is a vehicle; wherein dimension-indicative-properties of the vehicle comprise a type of vehicle, wherein the type of the vehicle is selected out of a truck, a van, a car, and a bus.

6. The method according to claim 1, wherein one of the objects is a two-wheeled vehicle; wherein dimension-indicative-properties of the two-wheeled vehicle comprise a type of vehicle, wherein the type of the vehicle is selected out of a bicycle, a motorcycle and a scooter.

7. The method according to claim 1, wherein one of the object is a pedestrian; wherein dimension-indicative-properties of the pedestrian comprise an age range of the pedestrian, wherein the age range is selected out of a child, an infant and an adult.

8. The method according to claim 1, comprising generating tagged sensed information units that comprise the sensed information units and the tags.

9. The method according to claim 8, comprising training one or more other machine learning processes with at least a first part of the tagged sensed information units.

10. The method according to claim 8, comprising testing one or more other machine learning processes with at least a second part of the tagged sensed information units.

11. The method according to claim 8, comprising performing an autonomous driving related operation by one or more other machine learning processes that were trained using at least some of the tagged sensed information units.

12. The method according to claim 1, wherein the obtaining of distance information comprises using a depth sensor that is selected out of a LIDER, a global positioning system (GPS) unit, a radar or a sonar.

13. A method for object detection, the method comprises:
obtaining one or more inference sensed information units of an environment of a vehicle; and
detecting one or more inference objects captured within the one or more sensed information units; wherein the detecting is executed, at least in part, by one or more object detection machine learning processes that were trained by tagged sensed information units; wherein the tagged sensed information units were generated by an automatic tagging process that comprises:
(g) obtaining sensed information units;
(h) obtaining distance information regarding distances between a training vehicle and objects captured in the sensed information units;
(i) identifying one or more dimension-indicative-properties related to the objects; the one or more dimension-indicative-properties related to the objects differ from one or more actual dimensions related to the objects;
(j) calculating the one or more actual dimensions related to the objects, based on the one or more dimension-indicative-properties related to the objects;
(k) determining one or more sensed information units dimensions related to the objects, based on the distance information and the one or more actual dimensions related to the objects; and
(l) generating tags associated with the objects, wherein the tags are indicative of at least one of (i) locations related to the objects within the sensed information units, and (ii) the one or more sensed information units dimensions related to the objects; and
wherein at least steps (c)-(f) are executed by one or more automatic tagging machine learning processes.

14. The method according to claim 12, comprising performing an autonomous driving related operation based on the detecting of the one or more objects.

15. A non-transitory computer readable medium for automatic tagging, the non-transitory computer readable medium stores instructions for:
(a) obtaining sensed information units;
(b) obtaining distance information regarding distances between a vehicle and objects captured in the sensed information units;
(c) identifying one or more dimension-indicative-properties related to the objects; the one or more dimension-indicative-properties related to the objects differ from one or more actual dimensions related to the objects;
(d) calculating the one or more actual dimensions related to the objects, based on the one or more dimension-indicative-properties related to the objects;
(e) determining one or more sensed information units dimensions related to the objects, based on the distance information and the one or more actual dimensions related to the objects; and
(f) generating tags associated with the objects, wherein the tags are indicative of at least one of (i) locations related to the objects within the sensed information units, and (ii) the one or more sensed information units dimensions related to the objects; and
wherein at least steps (c)-(f) are executed by using a machine learning process.

16. The non-transitory computer readable medium according to claim 1, wherein one or more sensed information units dimensions related to the objects are indicative of one or more dimensions of bounding shapes that are indicative of dimensions of the objects.

17. The non-transitory computer readable medium according to claim 1, wherein one or more sensed information units dimensions related to the objects are indicative of one or more dimensions of objects within the one or more sensed information units.

18. A vehicle processing circuit that is configured to:
obtain bounding shapes that bound objects, the objects were captured in a sensed information unit;
generate a cropped image for each bounding shape; segmenting each cropped image to a cropped image background and a cropped image foreground; and
generate, for each cropped image, an updated bounding shape that are indicative of dimensions of the cropped image foreground of the cropped image, to provide updated bounding shapes.
